(19) United States
(12) Patent Application Publication
(10) Pub. No.: US 2012/0245982 A1
(43) Pub. Date: Sep. 27, 2012

(54) Method and System of Providing and Presenting Content to a User

(75) Inventor: Dean A. Daniel, Potomac Falls, VA (US)

(73) Assignee: Dean Daniel, Potomac Falls, VA (US)

(21) Appl. No.: 13/413,395

(22) Filed: Mar. 6, 2012

Related U.S. Application Data
(60) Provisional application No. 61/465,446, filed on Mar. 21, 2011.

(51) Int. Cl. G06F 3/048; G06Q 30/02

(52) U.S. Cl. 705/14.4; 715/730

(57) ABSTRACT

Method of providing and presenting content to a user is disclosed. A user may provide inputs such as categories, topics, key words; inputs as to quantity, quality, emphasis and/or inclusion; inputs as to order of presentation, geography or temporal characteristics. These inputs are used to create a presentation format. This format is populated with content using a systemic program and algorithms. The content comes from various sources. The sources are selected by a secondary party that is not the user. A user may interact with the presentation by skipping, saving, rewinding, indicating like or dislike or requesting more related content. User interactivity is recorded by the systemic program. The systemic program records what content has been presented to a specific user so that a subsequent presentation does not repeat content. One result of this method is a personalized news and information radio station.

### FIELD OF THE EMBODIMENTS OF THE INVENTION

Embodiments of the invention are directed to methods and systems for providing and presenting content to a user.

### BACKGROUND OF THE EMBODIMENTS OF THE INVENTION

Radio stations present audio news, information and other non-music content in a broadcast format that each listener may not customize or interact with. This “one-size-fits-all”. presentation of news, information and other non-music content varies in benefit from individual to individual. A targeted group of “mainstream” listeners are generally satisfied enough to listen to the radio station but the utility of each listener is not maximized. Many other potential listeners do not receive enough benefit from the news, information and non-music content broadcast to warrant listening at all.

Improvements in computing technology, availability of broadband and the rising popularity of streamed media has created an environment in which audio streams tailored to each listener is practical and a growing expectation.

The inventor has invented a process by which the listener can receive personalized news, information and other non-music content in a radio format which the listener can interact with.

Our process differs from Patent Application 20030093794 in that our process is not completely automated as it is in 3794. The method herein allows that a secondary party (i.e. a person) other than the user selects the content sources and may screen individual content items and may prioritize content items.

Discretionary components are added to the method herein to resolve two issues. One, the method described herein could be used in a commercial operation. Content used for commercial purposes must be negotiated and paid for. Automatically extracting content from the universe of media as described in 3794 for commercial use would in nearly all circumstances be illegal. The content into the system described herein is controlled by a discrete method.

Two, automatically extracting content from available media sources per method 3794 inherently means the content is second hand news and, therefore, is older and less valuable. Additionally, automatic methods such as described in 3794 use the placement of the articles on a page or in a newscast to determine the significance. The method herein allows for the use of content direct from media sources such as newswires, which has to be judgmentally evaluated for its significance to determine its priority in a presentation and/or converted from a text newswire form to audio, hence the manual, discretionary components. As a result, the method herein can take breaking newswire content and include it in a user's presentation in a few minutes and do so before many sources that method 3794 would scan even exist.

### BRIEF SUMMARY OF EMBODIMENTS OF THE INVENTION

One example of our method of presenting and providing content to a user is a personalized news and information radio service. This audio service, through a Setup Interface, allows the user to input parameters which define the format of the radiocasted content to be received.

These format parameters include descriptions of the content; the quantity, quality, emphasis, inclusion and exclusion of content; length; geographic focus; and the order of the content.

Further enabling the receipt of content is an editor who receives news, information and other non-music content from a variety of sources and a reader who will covert text content to audio content. The editor will decide which content to make available to the user. Content made available to the user may be placed into categories like business, sports or technology, for example. Within a category content items are prioritized by the editor. Readers will convert, as necessary, text content selected by the editor to audio content. Readers convert text content to audio content in an order which conforms to the priority of the content give by the editor. Other news, information and non-music content may be made available to the user without categorizing or prioritizing by an editor. For example, stock quotes, weather data and Internet posts are made directly available to the user and are converted to audio content by voice synthesizing software. In yet another example, recorded traffic reports acquired from a third party, the content is already in audio form and does not require the use of voice synthesizing software.

Further enabling the receipt of content to the user, an automated process populates the user's format based on the format parameters entered by the user through the Setup Interface.

The populated format will be presented to the user in a radiocasted presentation.

The user may interact with an on-going presentation. The user may skip, save, retrieve, rewind, replay, pause, restart and forward presentation content. The user may request additional content related to a content item being presented or indicate a like or dislike of content.

While the presentation is on-going, new news, information and non-music content may be made available to the user before the presentation is complete. The remaining portion of the on-going presentation will be adjusted as necessary to accommodate newly available content.

User interactivity relating to skipping, saving, retrieving rewinding, replaying, pausing, restarting, forwarding, requesting more content, indicating “like” or indicating “dislike” will be stored as data. This date will be used by an algorithm to alter the priority of items which have been prioritized by the editor. The result is presentation content is more finely tuned to the user's preferences.

### BRIEF DESCRIPTION OF THE DRAWINGS

For a fuller understanding of the invention, reference is made to the following description, taken in connection with the accompanying drawings, in which:

FIG. 1 is a block diagram of the content presentation system.

FIG. 2 is an example of a user's setup interface.

FIG. 3 is an example of an editor's selection interface, which enables the editor to exercise discretion as to including or excluding the news article in a database of content that can be converted to audio and made available for user presentations.

FIG. 4 is an example of an editor's graphical interface for replacing, adding, deleting, copying, cutting, pasting and prioritizing news articles within categories and subcategories.

FIG. 5 is an example of an editor's graphical interface showing a news article's icon being appended to another related news article's icon (a side bar article).

FIG. 6 is an example of a reader's graphical interface for recording text news articles into audio files.

FIG. 7 is an example of a user's playback interface.

FIG. 8 is an example of a user's manual interface. FIG. 9 is an example of a user's saved interface.

### DETAILED DESCRIPTION OF EMBODIMENTS OF THE INVENTION

### Setup Interface and Program Format

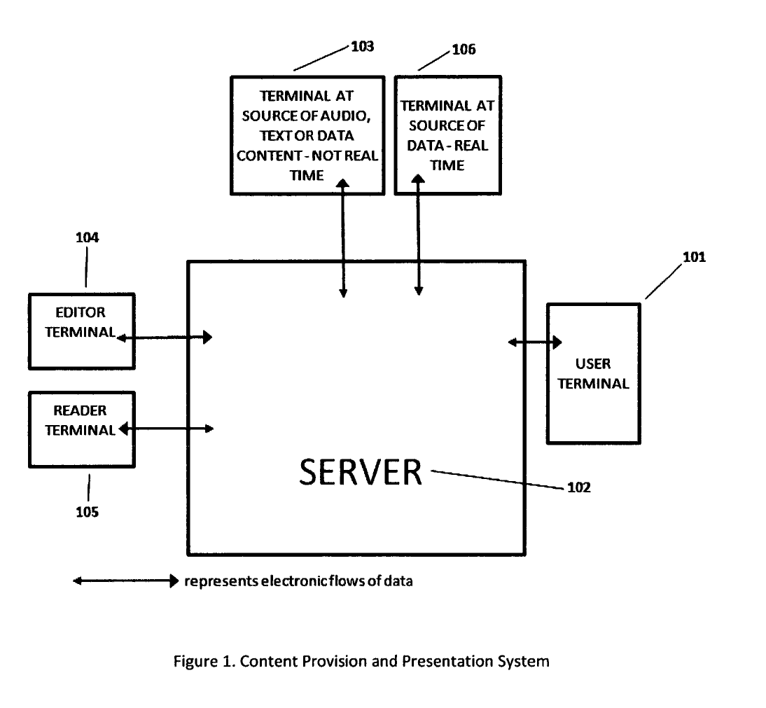

As per example in FIG. 1, the user or users communicate through a terminal 101 or terminals on an electronic network to a server computing device 102.

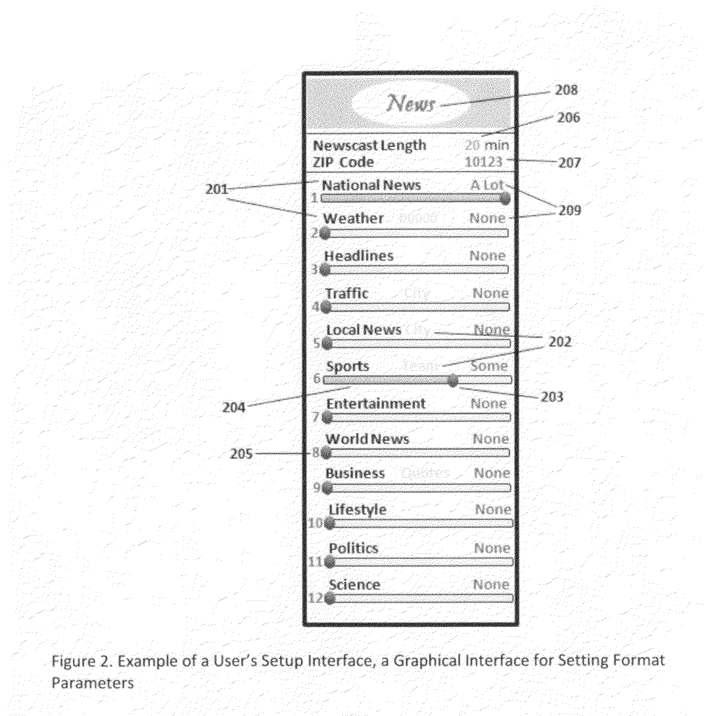

The user creates a presentation format by using a Setup Interface, see an example in FIG. 2, displayed by the user terminal 101. The Setup Interface is a graphical user interface. The Setup Inteface allows the input of format parameters, which are communicated over an electronic network to the server 102 where the format inputs are stored with an associated user identifier.

The Setup Interface enables the user to indicate what categories 201 (e.g. National News, Weather, Headlines, Traffic, Local News, Sports, Entertainment, World News, Business, Lifestyle, Politics, Science in FIG. 2) the user is interested in. Categories may include national news; weather; headlines; traffic; local news; sports; entertainment; world news; business; lifestyles, society, people and culture; special events, emergency alerts and breaking news; science and technology; traffic; postings (e.g. FaceBook), messages (e.g. Twitter and e-mail) and other topics.

The Setup Interface enables the user to indicate the inclusion of specific subcategories 202 (e.g. ZIP code, City, Team, Quotes in FIG. 2) the user is interested in. Subcategories may include location, team, sport, genre, entertainer, business, industry, hobbies, political party, scientific field and other topics.

The Setup Interface enables the user to indicate how much of a particular category to include or whether to exclude a category. A Quantity button 203 can be clicked and dragged to extend a bar 204 which represents the quantity of coverage requested by the user. As in the example of FIG. 2, the user could click and drag the sports category Quantity button to a position that indicates to the server 102 the user wants to receive “some” coverage of the category. As in the example of FIG. 2, the user could click and drag the weather category Quantity button to a position that indicates to the server 102 to exclude weather information.

The Setup Interface allows the user to indicate in what order to present categories. For example the user could “click and drag” a category and move it to a different location on the category list thereby changing the order in which categories are presented. Or for example, the user could renumber the category 205 by entering a new number and thus communicate to the server 102 the categories should be presented in a new order.

The Setup Interface allows the user to indicate how long a radiocast should last before recycling the format 206.

The Setup Interface allows the user or user GPS enabled terminal device to indicate where the user is located by including a town, ZIP code or other location identifier, which is used by the server when selecting regionally specific information like weather, traffic and local news 207.

All the input the user enters into the Setup Interface is stored and processed by the server 102 to create a program format.

The user can adjust and edit the presentation setup. The user initiates a presentation by activating the News button 208 on the user's Setup Interface, see example in FIG. 2. Additional feedback as to how much of a particular category has been requested by the user is provided in a text fields 209 presented for each category shown.

Multiple user terminals may be connected to the server 102 at one time.

### Accumulating, Editing and Reading News Articles

News articles come into the server from news wires and other providers using a terminal or multiple terminals 103 connected to the server 102 by an electronic network, see example in FIG. 1. The terminal can be another server controlled by the news provider. Some news wire services use procedures whereby the news articles are automatically sent or “pushed”. Other news article sources may require that the news articles be manually retrieved or “pulled” by the server 102.

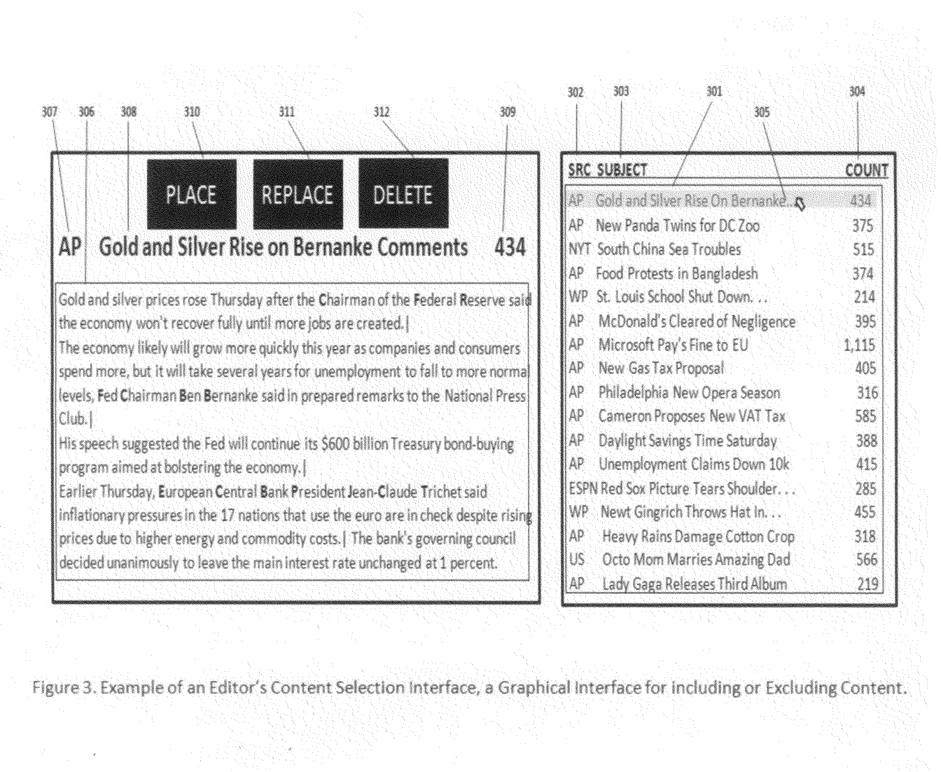

Each news article received and saved by the server 102 is presented on the editor's terminal 104, which is connected to the server 102 by an electronic network. Each news article presented to an editor is reviewed by the editor, who determines whether to delete the article or make it available to include in a presentation to a user. The editor communicates this decision through the editor's terminal 104 to the server 102. If the editor chooses to delete an article, the server 102 will delete the article. If not the server 102 will store and manage the article using the methods which follow. Each news article is reviewed by the editor using an Editor's Content Selection Interface, see example in FIG. 3.

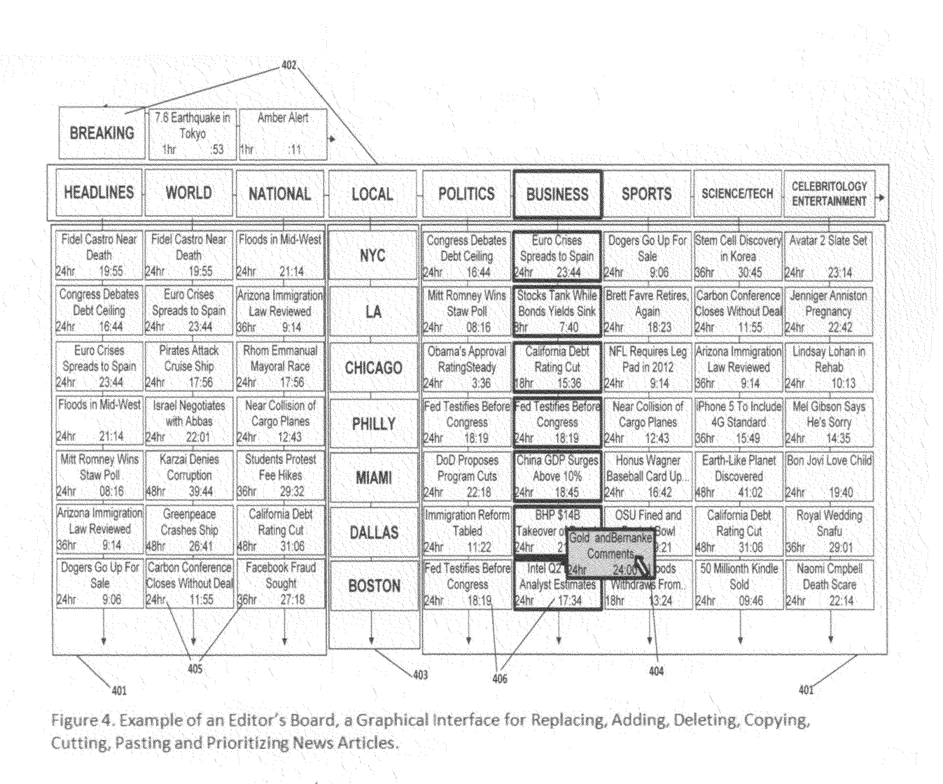

The Editor's Content Selection Interface includes a list of articles 301 to consider, which are identified by source 302, title 303 and word count 304. The editor selects and thereby highlights an article to review 305. The article selected to review is presented in full 306 in a separate screen location on the editor's terminal 104 along with the source 307, title 308 and word count 309. The text of the article may be edited. The editor may indicate to the server 102 for the selected article 306 to be placed on the Editor's Board, FIG. 4, by activating a Place button 310. The Editor's Board is a graphical interface and representation of a database of articles organized by categories, subcategories and article priority. The Editor's Board is maintained by the server 102. The editor may indicate to the server 102 for the selected article 306 to replace another article on the Editor's Board by activating a Replace button 311. The editor may indicate to the server 102 for the selected article 306 to deleted and not added to the Editor's Board by activating a Delete button 312.

The editor, through the editors terminal 104, uses the Editor's Board, FIG. 4, a graphical interface with the server 102, to replace, add, delete, copy, cut and paste icons 401, which represent articles, into various categories 402 (e.g. Headline, World, National, Local, Politics, Business, Sports, Science, Technology, Celebritology, Entertainment,) and subcategories 403 (e.g. individual localities like New York City, Los Angeles, Chicago, Philadelphia, Miami, Dallas, Boston, or Washington; individual political parties, individual industry segments or businesses, individual sports teams or sports, individual scientific fields, individual entertainment genres, individual celebrities, et cetera).

The Editor inserts articles onto the Editor's Board by “dragging and dropping” an article icon 404 which appears over the Editor's board after selecting Place 310 or Replace 311 for an article 306 when using the Editor's Content Selection Interface, FIG. 3. Where the article is “dropped” on the Editor's Board determines which categories or subcategories the article belongs in, and also determines the news article's priority among other articles in the same category or subcategory.

The server 102 will automatically assign a life span 405 for an article 401 and calculate the expiration time 406. These times 405, 406 can be edited by clicking on the article 401. The server 102 will automatically delete the article from the Editor's Board and make the article no longer available to be put in a presentation when the expiration time occurs.

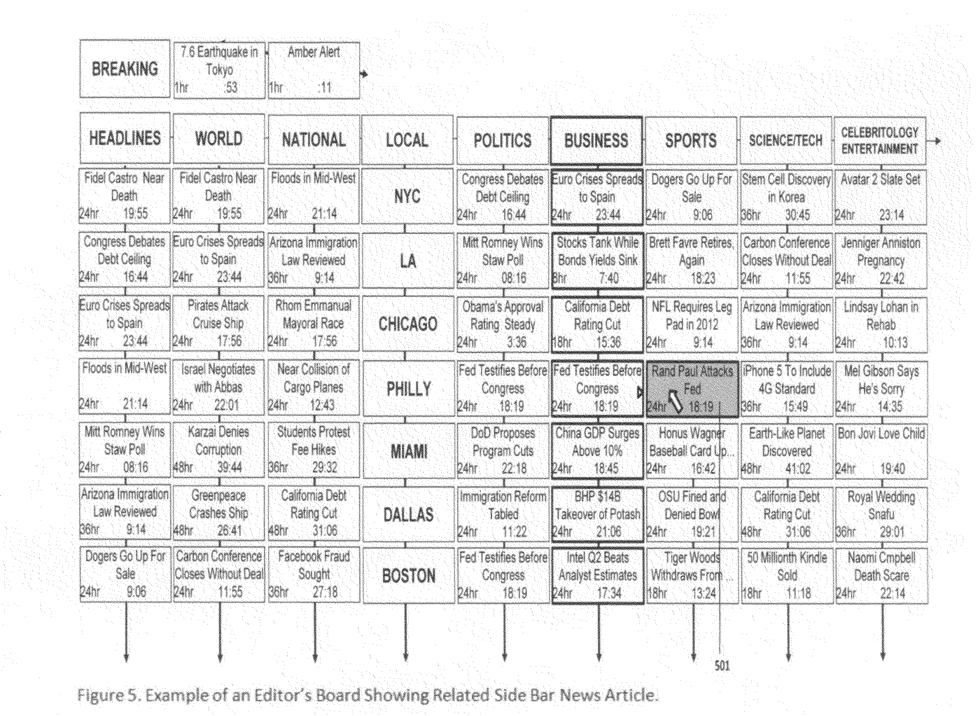

The editor may also append an article to another article that is similar in content by “dragging and dropping” an article icon 501 to the right side of an article already on the Editor's Board, see example in FIG. 5. The icon for the appending article appears over the Editor's board after selecting Place 310 or Replace 311 for an article when using the Editor's Content Selection Interface, FIG. 5. As in the example of FIG. 5, an article icon representing an article on Rand Paul's criticism of the Federal Reserve is appended to an article on Federal Reserve Testimony. Doing so will enable the user to access the appended article by activating the More button 708 on the Playback Interface described in methods below. Appended articles are not automatically included in a user's presentation—they are the audio equivalent of a magazine article's side bar.

Placing the cursor over a specific subcategory icon 403 will reveal the article icons under that subcategory. Placing the cursor over a specific article icon 401 will reveal any side bar articles which have been appended to the article icon 401.

Options to copy, cut, paste and delete an article icon 401 can also be exercised by the Editor through the Editor's Board by double clicking on or about an article icon 401 and selecting the option for copy, cut paste or delete presented on the Editor's Board graphical interface.

Article icons 404, 501 just added to the Editor's Board are still in text format only on the server 102 and have not been converted by a reader into audio format. They appear a different color on the Editor's Board from articles which have been read into an audio format 401. Article icons on the Editor's Board, which have not been read into audio form 404, 501 are automatically changed in color by the server 102 when the article has been read into an audio file by a reader using the methods described below.

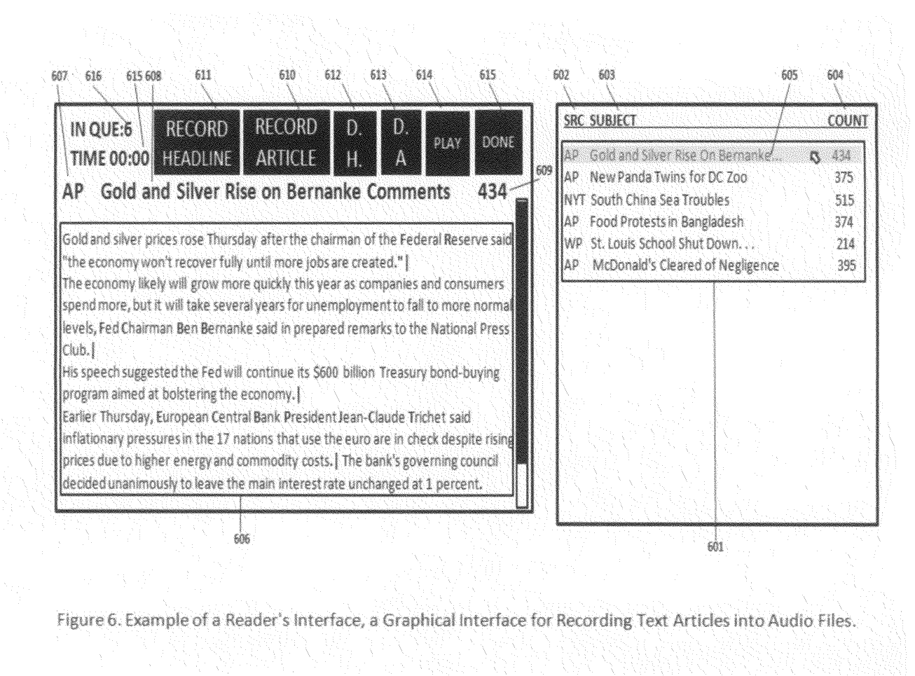

Articles newly added by an editor to the Editor's Board 404, 501 must be converted from text to an audio file. The server 102 communicates these newly added text articles to the reader's terminal 105 through an electronic network, see example in FIG. 1. The reader uses a Reader's Interface, see example in FIG. 6, presented on the reader's terminal 105 to record the conversion of text into an audio file. The Reader's Interface includes a list 601 of articles presented to the reader by the server 102. For each article listed 601, the Reader's Interface includes the source 602, title 603 and word count 604. The reader selects and thereby highlights an article 605 from the list 601 to record the article's audio file. The article selected to be converted into an audio file is presented in full 606 at a separate screen location on the reader's terminal 105 along with the source 607, title 608 and word count 609. The text of the article 606 may be edited. If editing changes the word count of the presented article 606, the word count display 609 will change to reflect the current number of words that resulted from editing.

The reader should record on the server 102 through the reader's terminal 105 using the Reader's Interface two versions of a news article: a longer “article” version and a briefer “headline” version. The “article” version is recorded on the server 102 by activating the Record Article button 610 followed by the reader reading aloud the article into the reader's terminal105. The “headline” version is recorded on the server 102 by activating the Record Headline button 611 followed by the reader reading aloud the article into the reader's terminal 105. When the reader is done recording an “article” version of the selected article 606 or wishes to pause, the reader again activates a Record Article button 610. When the reader is done recording the “headline” version of the selected article 606 or wishes to pause, the reader again activates said Record Headline button 611. If the reader wishes to delete the “headline” version of the audio for the selected 605 article, the reader activates a D.H. button 612. If the reader wishes to delete the “article” version of the audio for the selected 605 article, the reader activates a D.A. button 613. If the reader wishes to hear the current recording of the article selected 605, the reader activates a Play button 614. When the reader has completed all recordings for the selected article 605, the reader activates a Done button 615. Activating said Done button 615 causes the server 102 to remove the article 605 from the article list 601 and removes the article's text 606 from the Reader's Interface. Recorded audio files are stored on the server 102 and are available to be included in a user's presentation. Information detailing how many articles remain to be read into audio files 616 is also presented on the Reader's Interface.

Accumulating and Manipulating Other Information which is not News Articles

Information which becomes quickly outdated (e.g. temperature, time, and stock quotes) is obtained just before being streamed as part of the presentation to the user terminal 101. This real-time information is received by the server 102 through an electronic network from the information's source terminal 106. This data, as required by the user's format input, FIG. 2, will be added to user's presentation by the server 102 utilizing voice synthesizer technology.

Information which does not require reading and is not required to be obtained in real-time is received by the server 102 through an electronic network from terminals at the information sources 103 and is stored on the server 102. This data could include, for example, Twitter messages, audio traffic reports provided by third parties or advertisements. This data will be stored on the server 102 and, as required by the user's format input, FIG. 2, will be added to a user's presentation by the server 102.

Content from an information source terminal 103, 106 which is not converted into audio by a reader nor provided in an audio format will be converted into audio format using a voice synthesizing technology at the server 102. This data, for example, could include stock quotes, weather data and e-mail.

### Starting, Populating and Running a Presentation

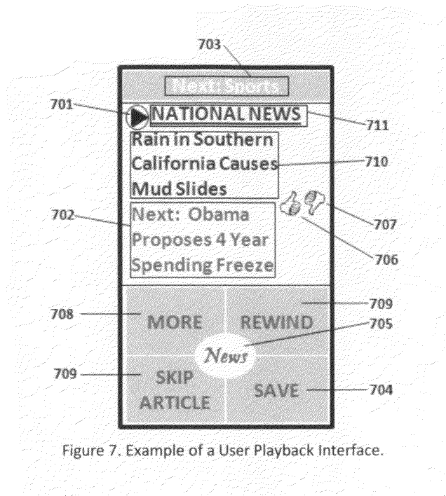

The user initiates a presentation by activating the News button 208 on the user's Setup Interface FIG. 2 presented on the user's terminal 101. Doing so will cause the server 102 to stream an audio logo or other introductory audio file to the user's terminal 101. In an alternate embodiment, the server 102 could cause the user's terminal 101 to stream an audio logo or other introductory audio file already on the user's terminal 101. This audio logo or other introductory file is designed to announce the beginning of the service and allow time for the server 102 to populate a presentation with content and buffer the content stream. Initiating a presentation by activating the news button 208 will also cause the Setup Interface, FIG. 2, to be replaced by the Playback Interface, FIG. 7, on the user's terminal 101.

The server 102 already holds audio files of news articles which have been categories, subcategorized and prioritized by the editor and read into audio files by a reader as described in methods detailed previously. The server 102 also Holds audio files provided by third parties such as traffic reports and text such as messages which can be read by a voice synthesizer as described in methods detailed previously.

When the server 102 receives a presentation request from a user's terminal 101, the server 102 will populate a presentation in accordance with the user's format input recorded on the server 102. The presentation will be populated with recorded audio (e.g. news articles, traffic reports); voice synthesized data (e.g. messages, e-mail) saved on the server 102; and real-time voice synthesized data (e.g. weather, sports scores) retrieved by the server 102 from a real-time information terminal 106. The categories 402 (e.g. world, sports, weather) selected by the user with the Input Interface would be played in the order the user selected during setup. Articles 401 within each category would be played in the order of priority set by the editor. Real-time information (e.g. stock quotes, sports scores) is retrieved by the server 102 from a real-time information terminal 106, converted into an audio file with a voice synthesizer and populated into the presentation just before it is needed in accordance with user format input. Where presentation time for a category is very limited, the server 102 will populate a presentation with shorter “headline” audio articles instead of full-length audio articles to ensure a variety of news. Advertisements and audio bumpers are periodically injected into the presentation by the server 102.

To illustrate populating a presentation, assume that the server 102 has recorded from the user Setup Interface, FIG. 2, that the user wants a 20 minute presentation. Assume the user has selected to receive “a lot” of business news followed by “a lot” of sports news. Also assume the server 102 is set to include in any presentation 4 minutes of advertisements and audio bumpers for every 20 minutes of presentation time. The server 102 would allocate the time of 20 minutes between the advertisements, audio bumpers and the news categories and information items selected by the user during setup. In this case, 4 minutes would be allocated to advertisements and audio bumpers, 8 minutes would be allocated for business news and 8 minutes would be allocated for sports news. Continuing our illustration, the server 102 would populate a user's presentation by first selecting the highest priority business audio article from the business category of recorded audio articles. Then the server 102 would continue to populate the presentation with each successively highest priority business audio article until the total audio time for business news articles approximated 8 minutes. Next the server would continue to populate the user's presentation by selecting from the sports category the highest priority sports audio article and then each successively highest priority sports audio article until the total audio time for sports news articles approximated 8 minutes.

After the audio files and non-real time voice synthesized information has been selected by the server 102 for the presentation, the presentation is streamed to the user's terminal 101.

If the server 102 has collected user interactivity data for the user during past presentations, described by methods which follow, the server 102 will adjust the priority of the articles within their respective categories to reflect the user's interest before selecting articles to populate a presentation. For example, if the user has recently saved audio articles on Dell Computers, the server algorithm may adjust the priority of an audio article on Dell Computers several places higher within its category. This, in turn, may result in the Dell Computers article being included in the user's presentation that otherwise would not have included the Dell Computer article.

If the server 102 has stored user input that includes a subcategory 202 through the Setup Interface, FIG. 2, the server 102 will increase the priority of related audio articles within the relevant category before selecting articles to populate the presentation. For example, if the user selected on the user Setup Interface to receive “a lot” of sports news and within that category selected the Washington Redskins subcategory, the server will increase the priority of audio articles on the Washington Redskins within the sports category to ensure that these Washington Redskins articles are included within the sports portion of the presentation.

New news articles, information or data may be received by the server 102 from an information source terminal 103, 106 and made available to populate a presentation after a user's presentation has been started. In some cases, this new content would have been selected to populate a user's on-going audio presentation had it been available at the start of the presentation. To address this issue, the server 102 will periodically repopulate an on-going audio cast. For example, assume a user's input includes time for the 5 highest priority political articles and that three political articles have already been presented to the user. Also assume a new article on a political scandal has now been placed at the top of the politics category by the editor, read into an audio file by a reader and made available for presentation. A periodic repopulating of the on-going presentation by the server 102 would now present the new political audio file as the fourth political article in the on-going presentation. The political article which was previously populated fourth in the presentation would now be the fifth political article presented. The political article which was previously populated fifth in the presentation would no longer be presented at all.

Historical data on what content has been presented to specific users during presentations is stored on the server 102 and referenced when populating presentations so that content that has already been heard by a specific user is not populated again by the server 102 during subsequent presentations to said specific user.

Interacting with a Presentation

The user initiates a presentation by activating a News button 208 on the user's Setup Interface FIG. 2 presented on the user's terminal 101. Initiating a presentation by activating a News button 208 will also cause the Setup Interface, FIG. 2, to be replaced by the Playback Interface, FIG. 7, on the user's terminal 101.

While a presentation is on-going, the user can interact with the server's 102 presentation though a graphical interface on the user terminal, see example in FIG. 7. When at the Playback Interface, the user can start, pause or restart a presentation in progress by activating a Play/Pause button 701.

The user can cause the server 102 to skip to the next article by activating an area where the next article is announced 702 or by activating a Skip Article button 709.

The user can cause the server 102 to skip to the next category by activating an area where the next category is announced 703.

The user can cause the server 102 to save an article or other audio file (e.g. advertisement) currently being presented by activating a Save button 704.

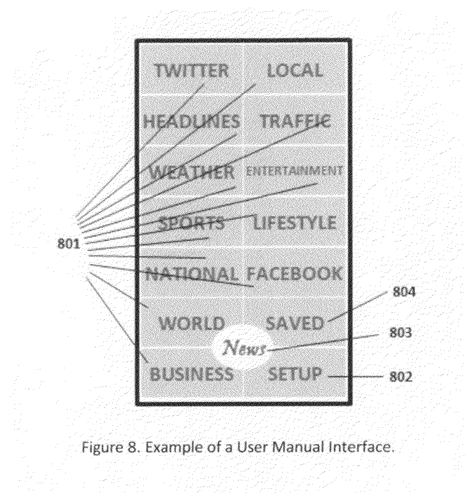

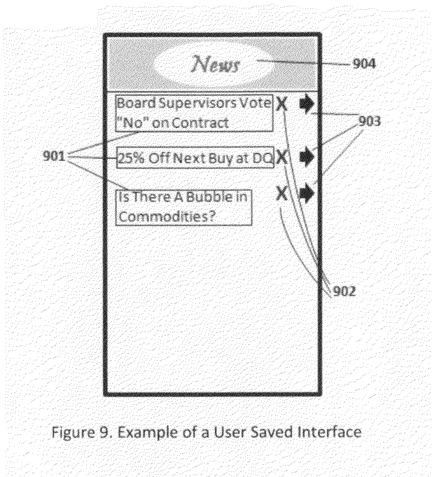

The user can cause the Playback Interface to be replaced by the Manual Interface, see example in FIG. 8, on the user terminal 101 by activating a News button 705 on the Playback Interface.

The user can indicate positive feedback for an news article being presented by activating a Positive Feedback button 706 or the user can indicate negative feedback for a news article being presented by activating a Negative Feedback button 707. This information will be stored at the server 102.

The user can request articles, which are related to an article being presented (i.e. sidebars), be added to the presentation by activating a More button 708. This will tell the server 102 to add to the presentation any news articles that were appended by the editor to the article currently being presented.

The user can cause the server to back up in a presentation by a fixed amount of time by activating a Rewind button 709. If the user immediately activates said Rewind button 709 a second time, the user will cause the server 102 to back up to the start of the article currently being presented. If the user continues to immediately activate said Rewind button 709, the server 102 will be caused to back up by one article or information item for each time said Rewind button 709 is activated.

The title of the article currently being presented is noted in a current article area 710. The category currently being presented is in a current category area 711.

The server 102 collects and stores all of the user's Playback Interface activity data, which is used to reprioritize the editor's prioritization of articles within each category just prior to the populating process. Doing so specializes presentations for each unique user.

The Manual Interface, FIG. 8, allows the user to interact manually with the server 102. Any of several buttons 801 each corresponding to a unique category can be activated to cause the server 102 to present articles only from the specific category the button represents. Articles from the requested category will be presented in the priority set by the editor and adjusted by the server 102 for any collected activity data.

The user can cause the Manual Interface to be replaced the Setup Interface, example in FIG. 2, on the user terminal 101 by activating a Setup button 802 on the Manual Interface.

The user can cause the Manual Interface to be replaced by the Playback Interface, example in FIG. 7, on the user terminal 101 by activating a News button 803 on the Manual Interface.

The user can cause the Manual Interface to be replaced by the Saved Interface, example in FIG. 9, on the user terminal 101 by activating a Saved button 804 on the Manual Interface.

The Saved Interface, FIG. 9, allows the user to retrieve audio articles or other audio files (e.g. advertisements) stored on the server 102. Each area containing the name of a saved audio article or other audio file 901, can be individually activated to cause the server 102 to play back the associated saved audio file. Each separately saved audio article or other audio file has its own delete symbol 902 that can be activated by the user causing the server 102 to delete the corresponding saved audio article or other audio file. Each separately saved audio article or other audio file has its own forward area 903 that can be activated by the user causing the server 102 to forward the corresponding saved audio article to a preset e-mail address.

The user can switch to the Manual Interface, example in FIG. 8, from the Saved Interface by activating a News button 904 on the Saved Interface.

### Presentation Recycling

When a presentation concludes, the user may start a subsequent presentation by activating a Play/Pause button 701 or a News button 208. The subsequent presentation will follow the same setup parameters, populating and presentation procedures as the first presentation except the server 102 will not allow articles and other content which would be repetitive to be available to populate a subsequent presentation.

### Other

While the invention has been described in connection with preferred embodiments, it will be understood that modifications thereof within the principles outlined above will be evident to those skilled in the art and thus, the invention is not limited to the preferred embodiments but is intended to encompass such modifications.

1. A method of presenting content to a user, comprising: enabling the user to provide inputs that create a presentation format and set parameters for a presentation of content.

2. The method of claim 1 wherein the input can be categories or subcategories or topics or subtopics or key words or subject identifiers.

3. The method of claim 1 wherein the input can be a quantity or quality or level of emphasis or inclusion or exclusion.

4. The method of claim 1 wherein the input can be temporal.

5. The method of claim 1 wherein the input can be a location.

6. The method of claim 1 wherein the input can be an ordering of format items.

7. The method of claim 1, further comprising enabling the user to modify format and parameter inputs.

8. The method of claim 1, further comprising that the format is systematically populated with available content.

9. The method of claim 8 where in content is related to time; weather; historical, current and projected events; information and data feeds; opinions, editorials or commentaries; sports; business; science and technology; lifestyles, society, people and culture; traffic; alerts; postings or messages; and advertisements.

10. The method of claim 8, further comprising that content is made available or selected or excluded at the discretion of a secondary party other than the user.

11. The method of claim 8, further comprising that content availability may be prioritized at the discretion of a secondary party other than the user such that the availability of content for systematic population into a presentation is increased or decreased.

12. The method of claim 11, further comprising that user inputs like selected topic, subtopics or key words may adjust the priorities of the secondary party in claim 11 and thus alter the content that populates a user's presentation as in claim 8.

13. The method of claim 8, further comprising that content availability for systematically populating into a user's presentation may be set to expire automatically at the discretion of a secondary party other than the user.

14. The method in claim 8, further comprising that the populated format is presented to the user in the format in claim 1.

15. The method of claim 14, where in the presentation is in audio form.

16. The method of claim 14, where in the presentation is in text form.

17. The method of claim 14, where in the presentation is in graphical form.

18. The method of claim 14, further comprising enabling the user to skip content being presented.

19. The method of claim 14, further comprising enabling the user to rewind or replay content being presented.

20. The method of claim 14, further comprising enabling the user to forward content being presented.

21. The method of claim 14, further comprising enabling the user to pause and/or restart the presentation of content.

22. The method of claim 14, further comprising enabling the user to save and/or retrieve content.

23. The method of claim 14, further comprising enabling the user to request more content related to the content being presented.

24. The method of claim 14, further comprising enabling the user to selectively provide feedback about the content being presented.

25. The method of claim 24, wherein the feedback is positive or negative feedback.

26. The method of claim 25, further comprising enabling, while the original population is being presented to the user, the unpresented part of the presentation may be repopulated based on changes in available content as in claim 8 and then presented as in claim 13.

27. The method of claim 14, further comprising enabling during presentation the recording of data relating to what content has been presented to specific users.

28. The method of claim 8, further enabling that recorded data relating to what content has been presented to specific users be used during the systematic population of a users presentation such that content is not repeated to a specific user.

29. The method of claim 14, further comprising enabling a secondary party on the secondary party's discretion to interrupt a user's presentation such that discretionary content can be inserted.

30. The method of claim 18, claim 19, claim 20 and claim 22, further enabling data about skipping, rewinding, replaying, forwarding, pausing, restarting, or saving to be collected.

31. The method of claim 30, further comprising enabling an analysis of collected data to adjust the priorities of the secondary party in claim 11 and thus alter the content that populates a user's presentation as in claim 8 and then presented as in claim 14.

32. The method of claim 1, further comprising the enabling of saving the input such that the input can be reused for subsequent presentations.

33. The method of claim 1, further comprising the enabling of the user to request a radiocast presentation.

34. The method of claim 33, further comprising that when presentations are requested, a media file on the users terminal or from the server is streamed introducing the service while the format is populated from available information and/or database content as in claim 8 and then buffered for the user.
